(19) United States
(12) Patent Application Publication
(10) Pub. No.: US 2003/0029068 A1
(43) Pub. Date: Feb. 13, 2003

(54) Plant marker

(76) Inventor: Terry J. Weber, Adell, WI (US)

Correspondence Address: Steven C. Becker, FOLEY & LARDNER, Firstar Center, 777 East Wisconsin Avenue, Milwaukee, WI, 53202-5367, US

(21) Appl. No.: 09/928,185

(22) Filed: Aug. 10, 2001

(51) Int. Cl. G09F 23/00

(52) U.S. Cl. 40/645

(57) ABSTRACT

A plant marker includes first and second surfaces coupled together and configured to pivot about an end. The second surface includes a stake extending therefrom. At least a portion of the stake is sized to fit within an aperture in the first surface.

### BACKGROUND OF THE DISCLOSURE

Gardeners have used a number of methods to mark where they have planted seeds and to assist them in remembering what has been planted. Some methods include the use of sticks, stones, small signs, and elaborate devices to retain seed packets including hollow, wooden devices and heavy-gauge plastic devices.

Sticks are commonly used by simply sticking them in the ground at the beginning of a row that has been planted or adjacent to the planted seeds. Sticks have also been used to anchor the empty seed packet at the planted location by poking the stick down through the seed packet and then into the ground or by placing the packet on top of a stick once it has been stuck in the ground. Stones have also been used to mark where seeds have been planted and they have been placed inside of seed packets to anchor them in location. Both of these methods, although simple, lack the important information printed on the packets when used without the seed packet, and when used with the seed packet, expose the seed packets to environmental elements causing the seed packets to quickly deteriorate or be blown away.

Small signs indicating the names of the seeds and other limited information are sometimes used to identify planted areas. Flat, wooden sticks and fanciful plastic and metal card holding devices are used. The primary disadvantage of using signs is that the information contained in the seed packets needs to be transposed onto them. Furthermore, they have a limited amount of space, they fail to take advantage of the graphics contained on the seed packet, and the written material often wears off quickly because it is exposed to environmental elements.

Some devices are made from an elaborate, hollow construction which are configured as multiple pieces, often of wood, plastic, metal or a combination thereof, to construct a very thin box with a viewing window to encapsulate a seed packet or other material. The devices further include a spike to anchor the thin box to the ground. Although these devices provide the gardener with protection from environmental elements, the complexity and cost of these devices prevents them from being effectively marketed.

Heavy-gauge, hard plastic devices are constructed from a very thick plastic material. This material, when folded in half, covers the seed packet. An additional piece of material is needed and is attached beneath the fold to prevent the packet from dropping out of the bottom. This device, like the elaborate hollow devices, is complex and costly to produce since multiple pieces are required, a heavy-gauge, hard plastic is required, and the design is more complex, thereby preventing these devices from being effectively marketed.

Accordingly, what is needed is an improved plant marker or seed packet holder which marks where specific seeds have been planted. Further, what is needed is a plant marker which provides some or all of the specific detailed information and pictures contained on the seed packet for easy viewing by a gardener. Further still, what is needed is a plant marker that protects a seed packet from environmental elements, such as rain, wind, and harmful ultraviolet radiation. Further yet, what is needed is a plant marker which has a simple design and an inexpensive cost to manufacture, but still provides sufficient rigidity to stick into the ground and retain a seed packet, including all of its pertinent information. The teachings hereinbelow extend to those embodiments which fall within the scope of the appended claims, regardless of whether they accomplish one or more of the above-mentioned needs.

### SUMMARY OF EXEMPLARY EMBODIMENTS

According to an exemplary embodiment, a plant marker includes a first surface having an end and an aperture, a second surface coupled to the first surface at the end, and a stake extending from the second surface. The first and second surfaces are configured to pivot about the end. At least a portion of the stake is sized to fit within the aperture.

According to another exemplary embodiment, a seed packet holder includes first and second surfaces foldable at a common edge and sized to hold a seed packet. The seed packet holder further includes a stake extending from one of the surfaces. The stake and the one surface are integrally molded in a single sheet. The seed packet holder further includes a fastening element configured to hold the first and second surfaces together.

According to yet another exemplary embodiment, a display case for a seed packet has a single sheet of substantially transparent material. The single sheet includes means for displaying the seed packet, means for securing the display case to soil, and means for retaining the seed packet within the display case.

According to still another exemplary embodiment, a display case includes a first surface defining an aperture, a second surface coupled to the first surface and foldable relative to the first surface between open and closed positions, and a protrusion extending from the second surface. The protrusion is configured to fit within the aperture. The first surface, second surface, and protrusion are fabricated from a single piece of material.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a front view of a plant marker, according to an exemplary embodiment;

FIG. 2 is a top view of the plant marker of FIG. 1, according to an exemplary embodiment;

FIG. 3 is a front view of the plant marker of FIG. 1 in a closed position, according to an exemplary embodiment;

FIG. 4 is a rear view of the plant marker of FIG. 1 in a closed position, according to an exemplary embodiment;

FIG. 5 is a side view of the plant marker of FIG. 1 in a closed position, according to an exemplary embodiment; and

FIG. 6 is a front view of a plant marker, according to an alternative embodiment.

### DETAILED DESCRIPTION OF EXEMPLARY EMBODIMENTS

Referring first to FIG. 1, a plant marker 10 is illustrated according to one exemplary embodiment. Plant marker 10 includes a first surface 12, a second surface 14, and a stake 16. In this embodiment, plant marker 10 is a unitary sheet of material, fabricated from a single piece of material. In alternative embodiments, one or more of first surface 12, second surface 14, and stake 16 may be fabricated from a single piece, wherein the other pieces are coupled to the first piece by a suitable fastener (e.g., glue, tape, staples, heat treating, or melting, etc.).

The material from which plant marker 12 is fabricated is an inexpensive, thin-gauge, ultraviolet light-inhibited, transparent plastic material in this exemplary embodiment. In alternative embodiments, one or more portions of the material of plant marker 12 may be slightly less transparent, colored, having a thicker gauge, and/or including materials other than plastics or polymers, such as, glass, etc. The single piece, thin gauge, transparent construction having ultraviolet light protection provides optimal advantages in this exemplary embodiment, but several advantages may be realized by the use of other materials. Preferably, at least one of surfaces 12 and 14 is sufficiently transparent to view at least a portion of a seed packet through the surface, and preferably, at least first surface 12 and second surface 14 are integrally molded in a single sheet (i.e., first and second surfaces 12 and 14 do not require a fastening element therebetween). Furthermore, by making at least one of first and second surfaces 12, 14 somewhat inhibitive of ultraviolet light, a seed packet retained therebetween is protected from sunlight damage.

Plant marker 12 preferably comprises a sheet of material which is greater than 0.015 inches thick and/or less than 0.100 inches thick. In alternative embodiments, other thicknesses of material may be used. Preferably, the sheet of material has a sufficient thickness and composition to allow for a fold 18 or crease at which surfaces 12 and 14 may pivot. Fold 18 is provided at an end of first surface 12 that is adjacent to an end of second surface 14. Fold 18 may be provided by scoring the material, by bending the material, or may be marked by a visible marking and/or partial scoring indicating a point at which a consumer is to fold the material. Fold 18 extends along the common pivot end of surfaces 12 and 14, and extends from a first side 20 to a second side 22 of plant marker 10. In alternative embodiments, fold 18 may extend at least part of the way between first and second sides 20, 22.

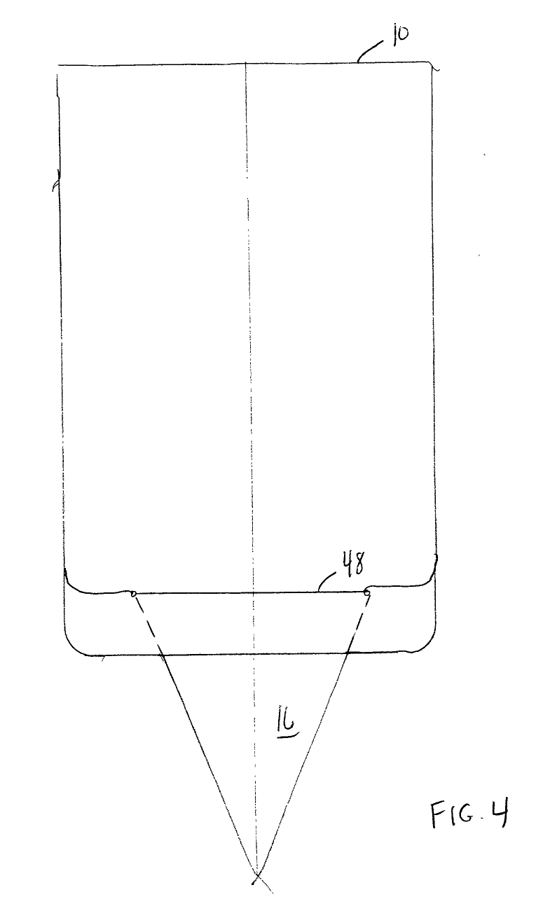

First and second surfaces 12, 14 are preferably sized and shaped to enclose a conventional seed packet when moved from a first, open position (illustrated in FIG. 1) to a second, closed position (illustrated in FIGS. 3 and 4). Thus, plant marker 10 may act as a seed packet holder foldable at fold 18, which is disposed on a common edge between first surface 12 and second surface 14. Seed packets may come in various sizes, and, therefore, first and second surfaces 12, 14 may also take different sizes. In this exemplary embodiment, a seed packet having a length of 4.5 inches and a width of 3.25 inches is accommodated by first and second surfaces 12, 14. Accordingly, first surface 12 has a length 24 of 5.5 inches and a width 26 of 3.5 inches, and second surface 14 has a length 28 of 5.0 inches and a width 26 of 3.5 inches. The surface areas of first and second surfaces 12, 14 may be approximately the same size as the seed packet contained therein, or may alternatively be somewhat larger than the seed packet, for example, ⅛ inch larger to ¼ inch larger on both length and width.

First surface 12 includes first and second corners 30, 32 on a top edge 62 opposite fold 18. Second surface 14 includes first and second corners 34, 36 on a bottom edge 63 opposite fold 18. One or more of corners 30, 32, 34, and 36 may be rounded to provide a smoother surface for easier manipulation by a person's fingers. In this embodiment, corners 30, 32, 34, and 36 have a radius of approximately ¼ inch.

Stake 16 is integrally molded with second surface 14 and extends therefrom away from first and second surfaces 12, 14. Stake 16 includes a base portion 38 adjoining second surface 14 and a sharp tip 40 configured for easily being driven into soil. In this embodiment, stake 16 is triangular in shape, but may alternatively be other shapes, including a rounded tip, or a tip having extended side walls 42 as illustrated in the alternative embodiment of FIG. 6.

Base 38 of stake 16 is spaced from first and second sides 20, 22 of plant marker 10 by a distance 74, preferably approximately ⅝ of an inch. Aperture 48 is provided at a distance 76 from first and second sides 20, 22, preferably approximately ⅝ of an inch. Stake 16 is a protrusion which meets with second surface 14 at corners 44, 46. In this embodiment, corners 44, 46 have a radius of approximately ⅛ inch.

First and second surfaces 12, 14 may include combinations of transparent, partially transparent, and opaque materials. Preferably, first and second surfaces 12, 14 are sized and composed of material that holds and displays at least one complete side of a seed packet.

First surface 12 further includes an aperture 48 which is a slit extending parallel with fold 18 having a length 50 of 2¼ inches in this exemplary embodiment. Stake 16 is also approximately 2¼ inches between corners 44 and 46, thereby making stake 16 suitable for insertion in aperture 48. In various alternative embodiments, aperture 48 may take different sizes and shapes provided at least a portion of stake 16 is sized to fit within aperture 48.

Referring now to FIG. 3, a front view of plant marker 10 is illustrated in a closed position. Specifically, first surface 12 is folded over second surface 14 and stake 16 is inserted within aperture 48. Apertures 52, 54 are provided on both ends of aperture 48 in this embodiment for the purpose of preventing tearing and/or cracking. In the closed position, stake 16 protrudes through aperture 48 and extends away from surfaces 12 and 14 to provide a load-bearing surface insertable in the soil and configured to support first and second surfaces 12, 14. A seed packet 56 is illustrated being sandwiched in between first and second surfaces 12, 14.

Notably, in the closed position illustrated in FIG. 3, stake 16 is aligned with and insertable into aperture 48. Stake 16 protrudes with a length sufficient to hold plant marker 10 upright when inserted into soil. Stake 16 has a length 78 of approximately 2¾ inches in this exemplary embodiment.

Various retaining or fastening elements may be provided to retain seed packet 56 in place between first and second surfaces 12, 14 and/or to fasten first surface 12 to second surface 14. In this exemplary embodiment, seed packet 56 is retained in place on a bottom edge 58 by the intersection of the base 38 of stake 16 with aperture 48 of first surface 12. In this manner, bottom edge 58 may rest upon base 38 at aperture 48 or in any event is prevented from falling beneath base 38 at aperture 48. A further retaining element is provided in the form of a crease 60 or fold extending perpendicular to fold 18 and extending along at least a portion of first surface 12 and/or second surface 14. In this embodiment, crease 60 extends from top edge 62 of plant marker 10 to tip 40 of stake 16. Crease 60 may be a pre-folded area, a scoring, a partially cut area, or a marking useable by a consumer to fold plant marker 10 at an angle.

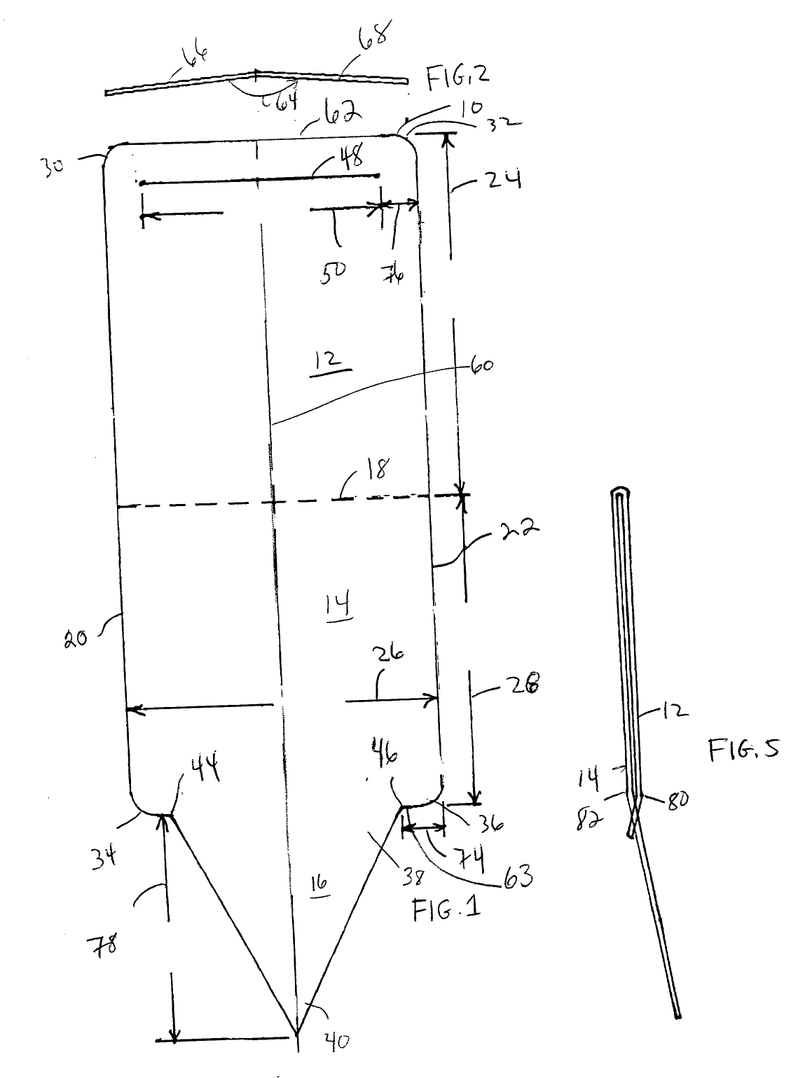

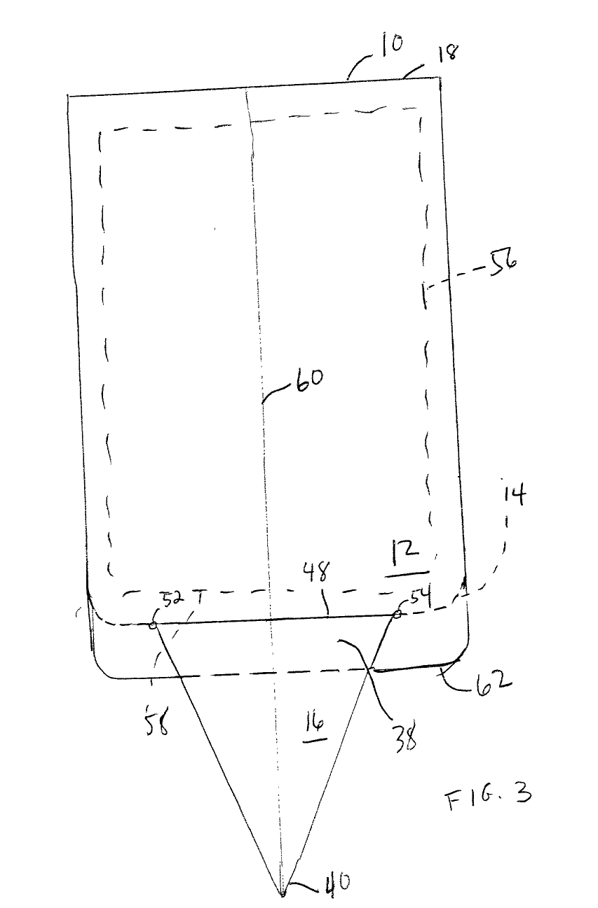

As illustrated in FIG. 2, an angle 64 is provided between a left portion 66 and a right portion 68 of plant marker 10. Angle 64 may be provided by a molding or other fabrication process, or may be provided by the consumer after purchase by simply folding left and right portions 66, 68 toward one another at crease 60. Upon folding left and right portion 66, 68 to achieve an angle 64 of less than 180 degrees, a friction or other force is imparted upon seed packet 56 at fold 60 to retain seed packet 56 in place.

Other structures or compositions for retaining seed packet 56 and/or to fasten first surface 12 to second surface 14 may be provided in addition to those illustrated in FIGS. 1 and 2 or in place thereof. For example, an adhesive or other sticky substance having a high coefficient of friction may be provided on either or both of first and second surfaces 12, 14 at a position or positions wherein seed packet 56 may be retained in place and/or at a position or positions wherein first and second surfaces 12, 14 may be fastened together. Other fastening structures and materials are contemplated. Preferably, the fastening element is molded from the same piece of material from which first surface 12, second surface 14, and/or stake 16 are provided.

Referring to FIG. 4, a rear view of plant marker 10 is illustrated. As shown, stake 16 extends through aperture 48 toward the front of plant marker 10.

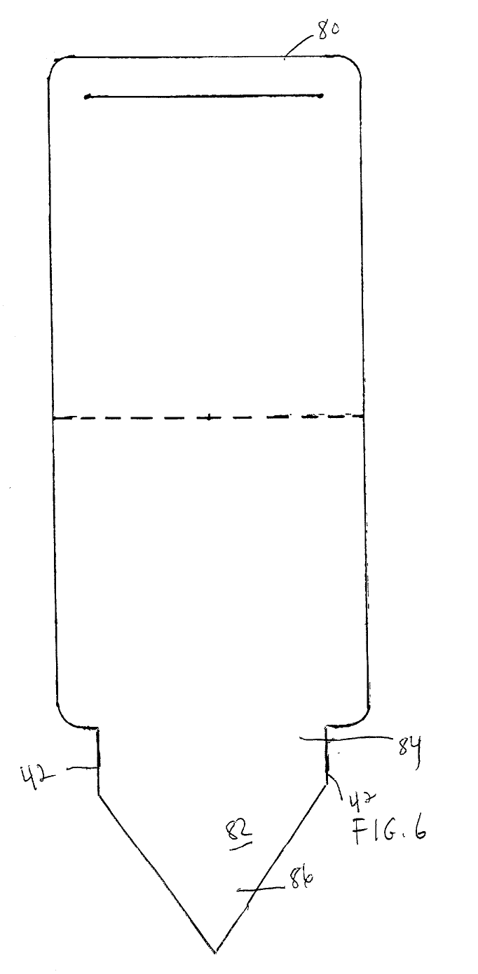

Referring to FIG. 5, a side view of plant marker 10 in a closed position is illustrated. The side view illustrates a bend 80 in first surface 12 and a bend 82 in second surface 14. Bends 80 and 82 may be fabricated into first and second surfaces 12, 14, or may be bent into the desired shape by the consumer. Alternatively, bends 80 and 82 may be absent.

Referring to FIG. 6, a front view of a plant marker 80 according to an alternative embodiment is illustrated. In this embodiment, stake 82 is shown having a different shape than the embodiment of FIG. 1. Specifically, stake 82 includes extended side walls 42 disposed between base 84 and tip 86 of stake 82. Also in this embodiment, crease 60 is absent.

Plant markers 10 and 80 may be fabricated by any of a number of fabrication processes, including die cutting, injection molding, casting, etc. Stake 16 and aperture 48 form an interlock to retain first and second surfaces 12, 14 to one another. Fold 18 and crease 60 provide rigidity to the plant markers and further retain the seed packet in place. Advantageously, some, most, or all of the information printed on the seed packets can be displayed, including a picture of the mature plant, through a portion of either or both of first and second surfaces 12, 14. In various embodiments, the plant marker can protect the seed packet from wind or rain, and further from ultraviolet light. The simple construction of the exemplary embodiments provides new and improved functionality, reuseability, and a manufacturing advantage in terms of costs to produce and marketability.

While the exemplary embodiments illustrated in the figures and described above are presently preferred, it should be understood that these embodiments are offered by way of example only. For example, the structure, materials, and forms illustrated herein may be applied to other display cases for items other than seed packets. Furthermore, various structures, shapes, and sizes of the stake may be provided to anchor the plant marker to the soil. Accordingly, the present invention is not limited to a particular embodiment, but extends to various modifications that nevertheless fall within the scope of the appended claims.

What is claimed is:

1. A plant marker, comprising:
a first surface having an end and an aperture;
a second surface coupled to the first surface at the end, wherein the first and second surfaces are configured to pivot about the end;
a stake extending from the second surface, wherein at least a portion of the stake is sized to fit within the aperture.

2. The plant marker of claim 1, wherein the first and second surfaces are configured to pivot from an open position to a closed position, wherein, in the closed position, the stake is aligned with the aperture.

3. The plant marker of claim 2, wherein, in the closed position, the stake is configured to extend through the aperture and away from the first and second surfaces with a length sufficient to hold the plant marker upright when inserted into soil.

4. The plant marker of claim 1, wherein the first and second surfaces are a unitary sheet of material and the pivot is a crease in the unitary sheet of material.

5. The plant marker of claim 4, wherein the first and second surfaces and the stake are a unitary sheet of material.

6. The plant marker of claim 5, wherein the unitary sheet of material is greater than 0.15 inches thick.

7. The plant marker of claim 5, wherein the unitary sheet of material is less than 0.100 inches thick.

8. The plant marker of claim 1, wherein the first and second surfaces include a crease extending perpendicular to the pivot end.

9. The plant marker of claim 1, wherein at least one of the first and second surfaces is substantially transparent.

10. The plant marker of claim 9, wherein the at least one of the first and second surfaces inhibits ultraviolet light.

11. The plant marker of claim 1, wherein the first surface has a second end opposite the end, wherein the second end has rounded corners.

12. A seed packet holder, comprising:
first and second surfaces foldable at a common edge and sized to hold a seed packet;
a stake extending from one of the surfaces, wherein the stake and the one surface are integrally molded in a single sheet; and
a fastening element configured to hold the first and second surfaces together.

13. The seed packet holder of claim 12, wherein the fastening element includes an aperture configured to receive the stake.

14. The seed packet holder of claim 12, wherein at least one of the surfaces is sufficiently transparent to view a seed packet through the surface.

15. The seed packet holder of claim 12, wherein the first surface and second surfaces are integrally molded in a single sheet.

16. A display case for a seed packet comprising a single sheet of substantially transparent material comprising means for displaying the seed packet, means for securing the display case to soil, and means for retaining the seed packet within the display case.

17. The display case of claim 16, wherein the means for retaining includes an aperture in the means for displaying.

18. The display case of claim 16, wherein the means for retaining includes a crease in the means for displaying.

19. The display case of claim 16, wherein the means for retaining includes both an aperture in the means for displaying and a crease in the means for displaying.

20. A display case, comprising:
a first surface defining an aperture;
a second surface coupled to the first surface and foldable relative to the first surface between open and closed positions; and
a protrusion extending from the second surface configured to fit within the aperture, wherein the first surface, second surface, and protrusion are fabricated from a single piece of material.

21. The display case of claim 20, wherein the first and second surfaces are sized to hold and display at least one complete side of a seed packet.

22. The display case of claim 20, wherein the protrusion is a stake.

23. The display case of claim 20, wherein at least one of the first and second surfaces is a substantially transparent material.

24. The display case of claim 20, wherein the aperture is a slit parallel to the fold between the first and second surfaces.
